(19) United States
(12) Patent Application Publication
(10) Pub. No.: US 2007/0157221 A1
(43) Pub. Date: Jul. 5, 2007

(54) System and method of providing television ratings information

(75) Inventors: Canhui Ou, Danville, CA (US); Peter Wong, Newark, CA (US)

Correspondence Address: TOLER SCHAFFER, LLP, 8500 BLUFFSTONE COVE, SUITE A201, AUSTIN, TX, 78759, US

(73) Assignee: SBC Knowledge Ventures, L.P., Reno, NV (US)

(21) Appl. No.: 11/318,293

(22) Filed: Dec. 23, 2005

(51) Int. Cl. H04H 9/00; H04N 7/16

(52) U.S. Cl. 725/10; 725/9; 725/13

(57) ABSTRACT

A system and method of providing television ratings information is disclosed. In a particular embodiment, the method includes determining aggregated audience data associated with a program carried over a channel. The aggregated audience data is collected from a number of set-top box devices associated with a multicast group of the channel. The method also includes receiving a request for real-time ratings information from a set-top box device and transmitting the real-time ratings information to the set-top box device. The real-time ratings information includes the aggregated audience data.

### FIELD OF THE DISCLOSURE

The present disclosure is generally related to providing ratings information.

### BACKGROUND

Technological advancements in television and video transmission services have enabled providers to offer viewers a broad range of entertainment. For example, evolutions from broadcast transmission, to off-air broadcasting, to cable and satellite transmissions have allowed content providers to increase programming from fifty channels to over five hundred channels, in just a decade. The increase in the number of available channels allows viewers to watch their favorite types of content, such as sports, comedy, news, and documentaries, at nearly any time of day, simply by switching to a channel that is dedicated to the content type.

The quantity and variety of content that television service providers offer can make choosing a program difficult. In many cases, viewers may wish to know what shows are most popular. In the past, ratings of the most popular television programming have been sampled and published by research organizations. These publications are available weeks or even months after a program airs. Thus, the ratings services are unlikely to help a viewer decide what to watch at a given time. Accordingly, there is a need for an improved system and method of providing television ratings information.

### BRIEF DESCRIPTION OF THE DRAWINGS

FIG. 1 is a block diagram illustrating an embodiment of an Internet Protocol Television (IPTV) system;

FIG. 2 is a block diagram illustrating an embodiment of a system to provide television ratings information;

FIG. 3 is a flow diagram illustrating an embodiment of a method of providing television ratings information;

FIG. 4 is a flow diagram illustrating a second embodiment of a method of providing television ratings information;

FIG. 5 is a flow diagram illustrating a method of receiving television ratings information;

FIG. 6 is a flow diagram illustrating a second method of receiving television ratings information;

FIG. 7 is a diagram of an illustrative embodiment of a graphical user interface to provide television ratings information;

FIG. 8 is a diagram of a second illustrative embodiment of a graphical user interface to provide television ratings information;

FIG. 9 is a diagram of a third illustrative embodiment of a graphical user interface to provide television ratings information; and

FIG. 10 is a diagram of an illustrative embodiment of a general computer system.

### DETAILED DESCRIPTION OF THE DRAWINGS

A system and method of providing television ratings information is disclosed. In a particular embodiment, the method includes determining aggregated audience data associated with a program carried over a channel. The aggregated audience data is collected from a number of set-top box devices associated with a multicast group of the channel. The method also includes receiving a request for real-time ratings information from a set-top box device and transmitting the real-time ratings information to the set-top box device. The real-time ratings information includes the aggregated audience data.

In another embodiment, a method of receiving television ratings information is disclosed and includes issuing a request for real-time ratings information from a set-top box device to a server, where the real-time ratings information includes aggregated audience data of a program carried over a channel. The method also includes receiving the real-time ratings information at the set-top box device. The aggregated audience data is determined based on a number of other set-top box devices associated with a multicast group of the channel.

In another embodiment, a system to provide television ratings information is disclosed and includes a server within an Internet Protocol Television (IPTV) system. The server having a processor and a memory device accessible to the processor. The memory device includes a ratings information module that is executable by the processor to determine aggregated audience data of a program carried over the channel. The aggregated audience data is collected from a number of set-top box devices associated with the multicast group. The ratings information module is executable by the processor to transmit real-time ratings information to a set-top box device via an access network of the IPTV system. The real-time ratings information transmitted in response to a request to receive the ratings information and includes the aggregated audience data.

In another embodiment, a system to receive television ratings information is disclosed and includes a set-top box having a processor and a memory device accessible to the processor. The memory device includes a command module that is executable by the processor to issue a join command to a server via an access network of an Internet Protocol Television (IPTV) system. The join command includes a command to add the set-top box to a multicast group of a channel. The memory device includes a ratings information module that is executable by the processor to issue a request to the server via the access network to receive real-time ratings information of a program carried over the channel. The real-time ratings information includes audience data of the program determined based on data from a number of set-top box devices associated with the multicast group.

In another embodiment, a computer program embedded in a computer-readable medium is disclosed and includes instructions to determine aggregated audience data of a program carried over a channel, where the aggregated audience data is collected from a number of set-top box devices associated with a multicast group of the channel. The computer program also includes instructions to receive a request for real-time ratings information from a set-top box device, where the real-time ratings information includes the aggregated audience data. The computer program also includes instructions to transmit the real-time ratings information to the set-top box device.

In another embodiment, a computer program embedded in a computer-readable medium is disclosed and includes instructions to issue a request for real-time ratings information from a set-top box device to a server via an access network of an Internet Protocol Television (IPTV) system, where the real-time ratings information includes aggregated audience data of a program carried over a channel. The aggregated audience data is determined based on data from a number of set-top box devices associated with a multicast group of the channel. The computer program also includes instructions to communicate with the server via the access network to receive the real-time ratings information at the set-top box device.

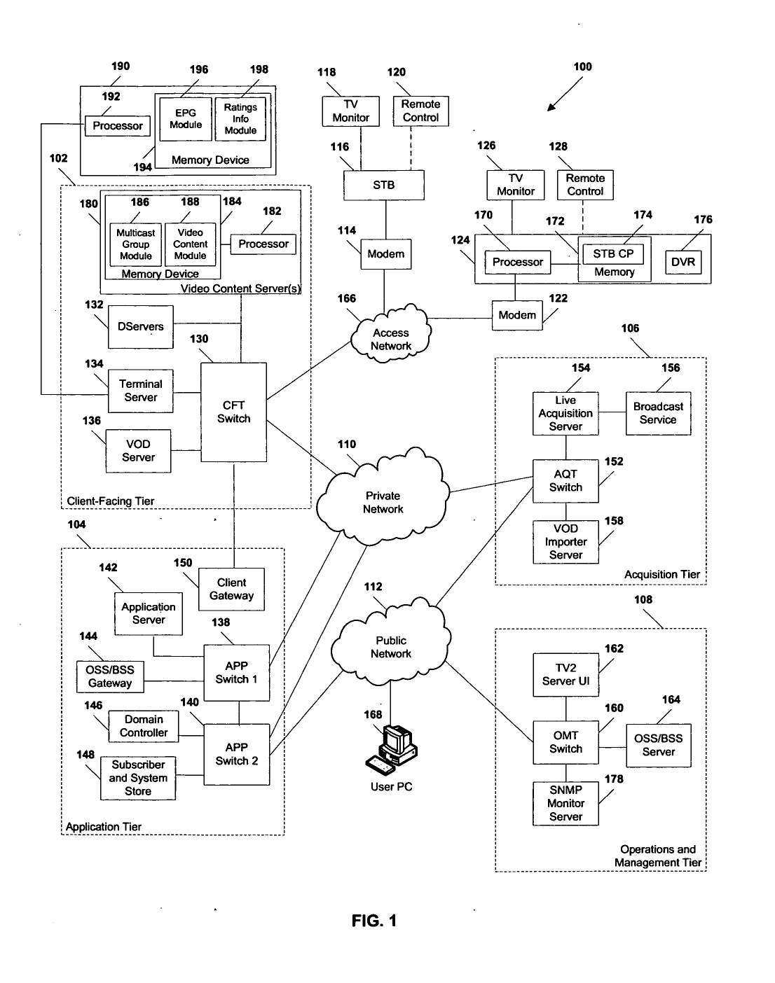

Referring to FIG. 1, an illustrative embodiment of an Internet Protocol Television (IPTV) system that may be used to provide television ratings information is illustrated and is generally designated 100. As shown, the system 100 can include a client facing tier 102, an application tier 104, an acquisition tier 106, and an operations and management tier 108. Each tier 102, 104, 106, 108 is coupled to a private network 110; to a public network 112, such as the Internet; or to both the private network 110 and the public network 112. For example, the client-facing tier 102 can be coupled to the private network 110. Further, the application tier 104 can be coupled to the private network 110 and to the public network 112. The acquisition tier 106 can also be coupled to the private network 110 and to the public network 112. Additionally, the operations and management tier 108 can be coupled to the public network 112.

As illustrated in FIG. 1, the various tiers 102, 104, 106, 108 communicate with each other via the private network 110 and the public network 112. For instance, the client-facing tier 102 can communicate with the application tier 104 and the acquisition tier 106 via the private network 110. The application tier 104 can also communicate with the acquisition tier 106 via the private network 110. Further, the application tier 104 can communicate with the acquisition tier 106 and the operations and management tier 108 via the public network 112. Moreover, the acquisition tier 106 can communicate with the operations and management tier 108 via the public network 112. In a particular embodiment, elements of the application tier 104, including, but not limited to, a client gateway 150, can communicate directly with the client-facing tier 102.

As illustrated in FIG. 1, the client-facing tier 102 can communicate with user equipment via a private access network 166, such as an Internet Protocol Television (IPTV) access network. In an illustrative embodiment, modems, such as a first modem 114 and a second modem 122 can be coupled to the private access network 166. The client-facing tier 102 can communicate with a first representative set-top box device 116 via the first modem 114 and with a second representative set-top box device 124 via the second modem 122. The client-facing tier 102 can communicate with a large number of set-top boxes, such as the representative set-top boxes 116, 124, over a wide geographic area, such as a regional area, a metropolitan area, a viewing area, a designated market area or any other suitable geographic area, market area, or subscriber or customer group that can be supported by networking the client-facing tier 102 to numerous set-top box devices. In an illustrative embodiment, the client-facing tier, or any portion thereof, can be included at a video head-end office.

In a particular embodiment, the client-facing tier 102 can be coupled to the modems 114, 122 via fiber optic cables. Alternatively, the modems 114 and 122 can be digital subscriber line (DSL) modems that are coupled to one or more network nodes via twisted pairs, and the client-facing tier 102 can be coupled to the network nodes via fiber-optic cables. Each set-top box device 116, 124 can process data received via the private access network 166, via an IPTV software platform, such as Microsoft® TV IPTV Edition.

Additionally, the first set-top box device 116 can be coupled to a first external display device, such as a first television monitor 118, and the second set-top box device 124 can be coupled to a second external display device, such as a second television monitor 126. Moreover, the first set-top box device 116 can communicate with a first remote control 120, and the second set-top box device can communicate with a second remote control 128. The set-top box devices 116, 124 can include IPTV set-top box devices; video gaming devices or consoles that are adapted to receive IPTV content; personal computers or other computing devices that are adapted to emulate set-top box device functionalities; any other device adapted to receive IPTV content and transmit data to an IPTV system via a private access network; or any combination thereof.

In an exemplary, non-limiting embodiment, each set-top box device 116, 124 can receive video content, which may include video and audio portions, from the client-facing tier 102 via the private access network 166. The set-top boxes 116, 124 can transmit the video content to an external display device, such as the television monitors 118, 126. Further, the set-top box devices 116, 124 can each include a STB processor, such as STB processor 170, and a STB memory device, such as STB memory 172, which is accessible to the STB processor 170. In one embodiment, a computer program, such as the STB computer program 174, can be embedded within the STB memory device 172. Each set-top box device 116, 124 can also include a video content storage module, such as a digital video recorder (DVR) 176. In a particular embodiment, the set-top box devices 116, 124 can communicate commands received from the remote control devices 120, 128 to the client-facing tier 102 via the private access network 166.

In an illustrative embodiment, the client-facing tier 102 can include a client-facing tier (CFT) switch 130 that manages communication between the client-facing tier 102 and the private access network 166 and between the client-facing tier 102 and the private network 110. As shown, the CFT switch 130 is coupled to one or more data servers, such as D-servers 132, that store, format, encode, replicate, or otherwise manipulate or prepare video content for communication from the IPTV system 100 to the set-top box devices 116, 124. The CFT switch 130 can also be coupled to a terminal server 134 that provides terminal devices, such as a program information server 190, with a connection point to the private network 110. In a particular embodiment, the CFT switch 130 can also be coupled to a video-on-demand (VOD) server 136 that stores or provides VOD content imported by the IPTV system 100.

In a particular embodiment, the CFT switch 130 can also be coupled to one or more video content servers 180. The video content server(s) 180 can include a cluster of video content servers, such as a group of multicast video content servers. Each video content server 180 includes a processor 182 and a memory device 184. In one embodiment, the memory device 184 of each video content server 180 can include one or more modules 186, 188 that are executable by the processor 182. For example, the memory device 184 of each video content server 180 can include a multicast group module 186 executable by the processor 182 to manipulate multicast groups in response to join commands or leave commands issued by the set-top box devices 116, 124. Additionally, the memory device 184 of each video content server 180 can include a video content module 186 executable by the processor 182 to provide video content of a channel to the set-top boxes 116, 124 within one or more multicast groups.

As illustrated in FIG. 1, the application tier 104 can communicate with both the private network 110 and the public network 112. The application tier 104 can include a first application tier (APP) switch 138 and a second APP switch 140. In a particular embodiment, the first APP switch 138 can be coupled to the second APP switch 140. The first APP switch 138 can be coupled to an application server 142 and to an OSS/BSS gateway 144. In a particular embodiment, the application server 142 can provide applications to the set-top box devices 116, 124 via the private access network 166, which enable the set-top box devices 116, 124 to provide functions, such as display, messaging, processing of IPTV data and VOD material, etc. In a particular embodiment, the OSS/BSS gateway 144 includes operation systems and support (OSS) data, as well as billing systems and support (BSS) data. In one embodiment, the OSS/BSS gateway 144 can provide or restrict access to an OSS/BSS server 164 that stores operations and billing systems data.

Further, the second APP switch 140 can be coupled to a domain controller 146 that provides Internet access, for example, to users via the public network 112. For example, the domain controller 146 can provide remote Internet access to IPTV account information, e-mail, personalized Internet services, or other online services via the public network 112. Users can access such information or services using their personal computers 168. The second APP switch 140 can be coupled to a subscriber and system store 148 that includes account information, such as account information that is associated with users who access the system 100 via the private network 110 or the public network 112. Additionally, the second APP switch 140 can be coupled to one or more interactive voice response (IVR) servers 182 that can communicate with a user telephone 184 via the public network 112.

In a particular embodiment, the application tier 104 can also include a client gateway 150 that communicates data directly with the client-facing tier 102. In this embodiment, the client gateway 150 can be coupled directly to the CFT switch 130. The client gateway 150 can provide or restrict access to the private network 110 and the tiers coupled thereto.

In a particular embodiment, the set-top box devices 116, 124 can access the IPTV system 100 via the private access network 166, using information received from the client gateway 150. In this embodiment, the private access network 166 can provide security for the private network 110. User devices can access the client gateway 150 via the private access network 166, and the client gateway 150 can allow such devices to access the private network 110 once the devices are authenticated or verified. Similarly, the client gateway 150 can prevent unauthorized devices, such as hacker computers or stolen set-top box devices from accessing the private network 110, by denying access to these devices beyond the private access network 166.

For example, when the first representative set-top box device 116 accesses the system 100 via the private access network 166, the client gateway 150 can verify subscriber information by communicating with the subscriber and system store 148 via the private network 110, the first APP switch 138, and the second APP switch 140. Further, the client gateway 150 can verify billing information and status by communicating with the OSS/BSS gateway 144 via the private network 110 and the first APP switch 138. In one embodiment, the OSS/BSS gateway 144 can transmit a query via the first APP switch 138, to the second APP switch 140, and the second APP switch 140 can communicate the query via the public network 112 to the OSS/BSS server 164. After the client gateway 150 confirms subscriber and/or billing information, the client gateway 150 can allow the set-top box device 116 to access IPTV content and VOD content. If the client gateway 150 cannot verify subscriber information for the set-top box device 116, e.g., because it is connected to an unauthorized twisted pair, the client gateway 150 can block transmissions to and from the set-top box device 116 beyond the private access network 166.

As indicated in FIG. 1, the acquisition tier 106 includes an acquisition tier (AQT) switch 152 that communicates with the private network 110. The AQT switch 152 can also communicate with the operations and management tier 108 via the public network 112. In a particular embodiment, the AQT switch 152 can be coupled to a live acquisition server 154 that receives or acquires television or movie content, for example, from a broadcast service 156. In a particular embodiment, the live acquisition server 154 can transmit the television or movie content to the AQT switch 152, and the AQT switch 152 can transmit the television or movie content to the CFT switch 130 via the private network 110.

Further, the television or movie content can be transmitted to the D-servers 132, where it can be encoded, formatted, stored, replicated, or otherwise manipulated and prepared for communication to the set-top box devices 116, 124. The CFT switch 130 can receive the television or movie content from the D-servers 132 and communicate the content to the modems 114, 122 via the private access network 166. The set-top box devices 116, 124 can receive the television or movie content via the modems 114, 122, and can transmit the television or movie content to the television monitors 118, 126. In an illustrative embodiment, video or audio portions of the television or movie content can be streamed to the set-top box devices 116, 124.

Further, the AQT switch can be coupled to a video-on-demand importer server 158 that stores television or movie content received at the acquisition tier 106 and communicates the stored content to the VOD server 136 at the client-facing tier 102 via the private network 110. Additionally, at the acquisition tier 106, the video-on-demand (VOD) importer server 158 can receive content from one or more VOD sources outside the IPTV system 100, such as movie studios and programmers of non-live content. The VOD importer server 158 can transmit the VOD content to the AQT switch 152, and the AQT switch 152, in turn, can communicate the material to the CFT switch 130 via the private network 110. The VOD content can be stored at one or more servers, such as the VOD server 136.

When users issue requests for VOD content via the set-top box devices 116, 124, the requests can be transmitted over the private access network 166 to the VOD server 136, via the CFT switch 130. Upon receiving such requests, the VOD server 136 can retrieve the requested VOD content and transmit the content to the set-top box devices 116,124 across the private access network 166, via the CFT switch 130. The set-top box devices 116, 124 can transmit the VOD content to the television monitors 118, 126. In an illustrative embodiment, video or audio portions of VOD content can be streamed to the set-top box devices 116, 124.

FIG. 1 further illustrates that the operations and management tier 108 can include an operations and management tier (OMT) switch 160 that conducts communication between the operations and management tier 108 and the public network 112. In the embodiment illustrated by FIG. 1, the OMT switch 160 is coupled to a TV2 server 162. Additionally, the OMT switch 160 can be coupled to an OSS/BSS server 164 and to a simple network management protocol (SNMP) monitor 170 that monitors network devices within or coupled to the IPTV system 100. In a particular embodiment, the OMT switch 160 can communicate with the AQT switch 152 via the public network 112.

In an illustrative embodiment, the live acquisition server 154 can transmit the television or movie content to the AQT switch 152, and the AQT switch 152, in turn, can transmit the television or movie content to the OMT switch 160 via the public network 112. In this embodiment, the OMT switch 160 can transmit the television or movie content to the TV2 server 162 for display to users accessing the user interface at the TV2 server 162. For example, a user can access the TV2 server 162 using a personal computer (PC) 168 coupled to the public network 112.

In a particular embodiment, a user can issue a request to a set-top box device, such as the second representative set-top box device 124, to view an electronic program guide (EPG). The set-top box processor 170 can be configured to transmit the request to a program information server 190 via the CFT switch 130. The memory device 194 of the program information server 190 can include an EPG module 196 that is executable by the processor 192 to generate the EPG and transmit the EPG to the set-top box device 124 over the private access network 166. The set-top box device 124 can receive the EPG via a modem 122, for example, and transmit the EPG to a television monitor 126 that is coupled to the set-top box device 124.

In an illustrative embodiment, the EPG can include an indicator of a selectable option to view real-time ratings information related to one or more programs displayed on the EPG. If the viewer desires to review real-time ratings information, the viewer can issue a command to receive the real-time ratings information, for example, by pressing a ratings information button on a remote control 128 or by using a remote control 128 to select a soft button displayed on the EPG. The set-top box device 124 can issue a request for the real-time ratings information to the program information server 190. The program information server memory device 194 can include a ratings information module 198 that is executable by the processor 192 to acquire real-time ratings information from the video content servers 180 and to transmit an updated EPG having the real-time ratings information to the set-top box device 124 for display at the television monitor 126.

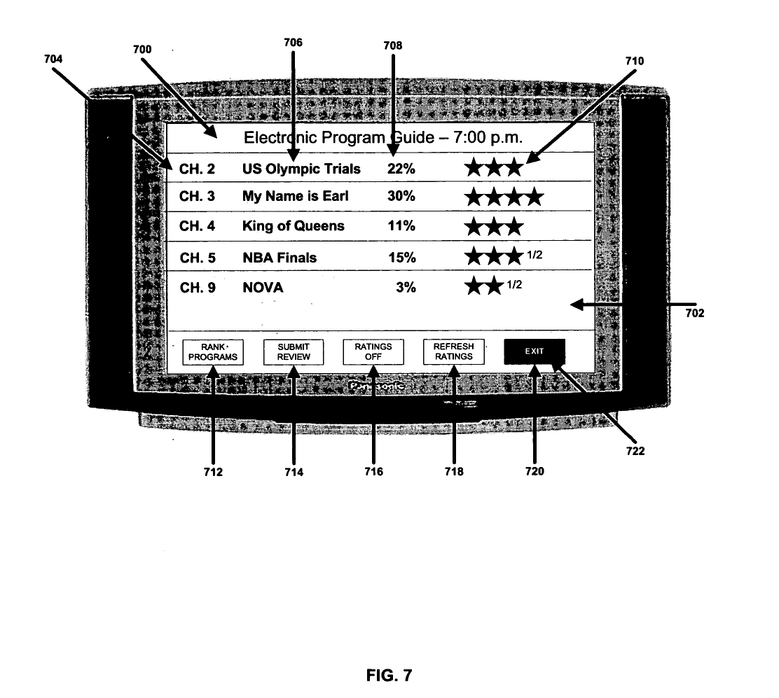

In a particular embodiment, the real-time ratings information can include audience data related to the program(s), such as a number or percentage of set-top boxes within a nationwide area, region, state, metropolitan area, neighborhood, or other market area, which are receiving each program. Alternatively, the audience data can also be a statistical estimation of total viewers, based on the number of set-top devices receiving each program. In another embodiment, the real-time ratings information can include reviews of one or more programs displayed on the EPG. A review can be, for example, an average review submitted from set-top boxes within an area that are receiving or have received a program. In an illustrative embodiment, each review can be expressed as one or more integers, such as ‘9 out of 10’ or as a number of stars, such as ‘4 out of 5 stars.’ An example embodiment of an EPG having real-time ratings information is illustrated further in FIG. 7.

In an illustrative embodiment, the program information server 190 can obtain audience data for a program by determining the number of set-top boxes in a multicast group of a channel that is carrying the program. Each time that a join command or leave command is issued by a set-top box device 116, 124 that changes to or from a channel, the number of set-top boxes in the multicast group of the channel can be updated at a multicast group module 186 of the video content server 180 that is supplying the video content carried by the channel. In a particular embodiment, the ratings information module 198 of the program information server 190 can be executable by the processor to determine the number of set-top boxes in the multicast group of each channel displayed by the EPG, e.g., by retrieving data from each video content server 180, at periodic time intervals or when a request for real-time ratings information is received.

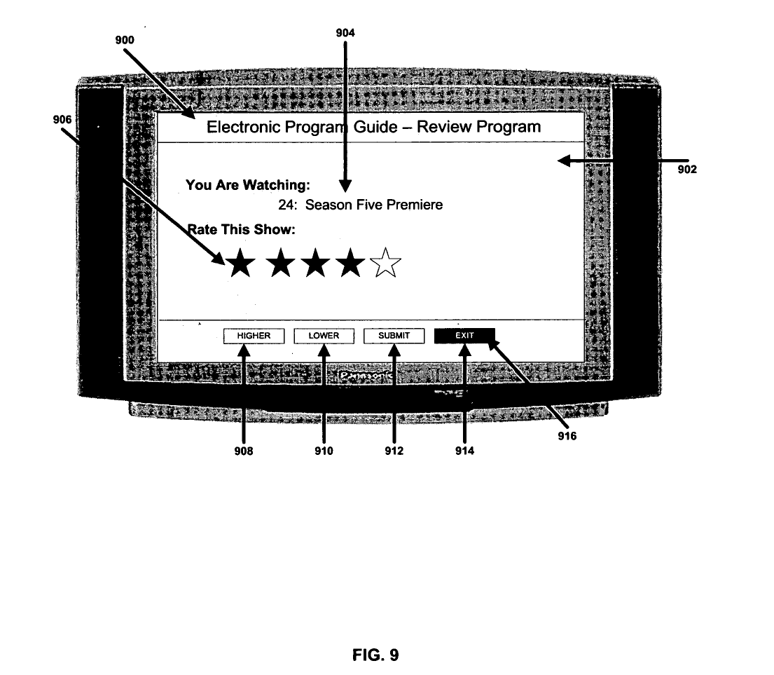

In a particular embodiment, the program information server 190 can maintain reviews of one or more programs by storing data related to reviews received from individual set-top boxes. A user can submit a review by pressing a review submission key on a remote control 128. Alternatively, the EPG can include an indicator of a selectable option to submit a review. A user can select the indicator using a remote control 128, for example, and the set-top box device can transmit a prompt for the review to the display device 126. The user can input a review of the program, such as a number of stars, and the set-top box device 124 can transmit the review to the program information server 190. The review can be stored in the ratings information module 198 or it can be used to calculate an average review of the program that is stored in the ratings information module 198. An example embodiment of a graphical user interface to prompt a user to submit a review is illustrated in FIG. 9.

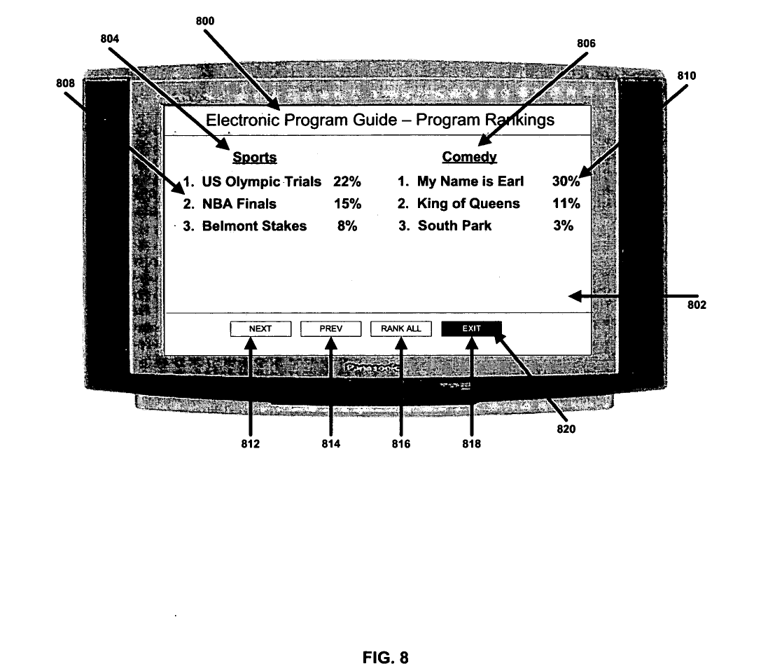

In an illustrative embodiment, the EPG can include an indicator of a selectable option to receive program rankings based on audience data or reviews. The set-top box device 124 can receive a selection of the indicator from the user via the remote control 128 and transmit a request for program rankings to the program information server 190. The program information server 190 can compare audience data for various programs, for instance, by comparing the sizes of multicast groups of channels carrying the programs, and the program information server 190 can arrange the programs into a ranked list. The program information server 190 can transmit the ranked list to the set-top box device 124. In an illustrative embodiment, the user may issue a command to the program information server 190, via the set-top box device 124, to segment the rankings by program type, such as sports, comedy, drama, action, news, documentary, educational, movie, or another program type. An example embodiment of a graphical user interface to display ranked programs is illustrated further in FIG. 8.

In an alternative embodiment, a user can issue a request to the set-top box device 124 to view the electronic program guide (EPG). The set-top box processor 170 can be configured to request data related to the EPG from the program information server 190. The program information server 190 can transmit the data to the set-top box device 124 in response to the request. The memory device 172 of the set-top box device 124 can include a computer program 174 that is executable by the set-top box processor 170 to generate the EPG and transmit the EPG to the television monitor 126.

In an illustrative embodiment, the EPG can include an indicator of a selectable option to view real-time ratings information related to one or more programs displayed on the EPG. If the user desires to review real-time ratings information, the viewer can issue a command to receive the real-time ratings information, for example, by pressing a ratings information button on a remote control 128 or by using a remote control 128 to select a soft button displayed on the EPG. The set-top box device 124 can issue a request for data related to the real-time ratings information to the program information server 190. In a particular embodiment, the set-top box computer program 174 can be executable by the set-top box processor 172 to generate an updated EPG having the ratings information and transmit the EPG to the television monitor 126.

In another particular embodiment, the EPG can include an indicator of a selectable option to receive program rankings based on audience data or reviews. The set-top box computer program 174 can be executable by the set-top box processor 172 to compare audience data or reviews of ranked programs and to transmit the ranked list to the set-top box device 124. In an illustrative embodiment, the user may issue a command to the set-top box device 124 to segment the rankings by program type, such as sports, comedy, drama, action, news, documentary, educational, movie, or another program type.

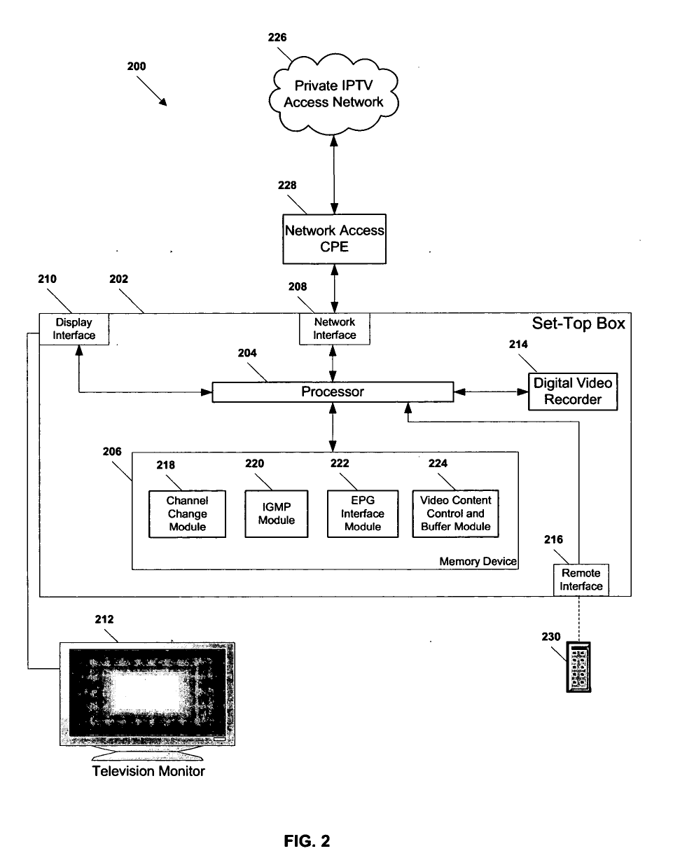

Referring to FIG. 2, an embodiment of a system to receive television ratings information is illustrated and designated generally at 200. The system includes a set-top box 202 that contains a processor 204 and a memory device 206 that is accessible to the processor 204. Additionally, the processor 204 is coupled to a network interface 208. Further, the processor 204 can be coupled to a display interface 210, such as a television interface, through which the set-top box device 202 can communicate video content, television ratings information, or other content to an external display device, such as a television monitor 212. In addition, the processor 204 can communicate with a remote control device 230, via a remote control interface 216.

The processor 204 can communicate with an external access network, such as a private Internet Protocol Television (IPTV) access network 226, via the network interface 208. In an illustrative, non-limiting embodiment, the private IPTV access network 226 can be the private access network 166 illustrated in FIG. 1. In a particular embodiment, network access customer premises equipment (CPE) 228 can facilitate communication between the network interface 208 and the private IPTV access network 226. The network access CPE 228 can include a router, a local area network device, a modem, such as a digital subscriber line (DSL) modem, any other suitable device for facilitating communication between the network interface 208 of the set-top box device 202 and the private IPTV access network 226, or any combination thereof. In an illustrative, non-limiting embodiment, the network access CPE 228 can be the modem 114 or 122 illustrated in FIG. 1.

In a particular embodiment, the memory device 206 can include a channel change module 218. The channel change module 218 can be executable by the processor 204 to receive a channel change request from a user, for example, via the remote control device 230. In an illustrative embodiment, the memory device 206 can also include an Internet Group Management Protocol (IGMP) module 220 that is executable by the processor 204 to issue a join command to a server within an IPTV system via the private IPTV access network 226, in response to the channel change request. The join command can be a command to be added to a multicast group of a requested channel. In a particular embodiment, the IGMP module 220 can also be executable by the processor 204 to issue a leave command to the server within the IPTV system, in response to the channel change request, to be removed from a multicast group of the channel from which the user requests a change.

The memory device 206 can include an electronic program guide (EPG) interface module 222 that is executable by the processor 204 to receive a request for an EPG from a user. In a particular embodiment, the EPG interface module 222 can be executable by the processor 204 to request an EPG from a server within the IPTV system and to receive the EPG via the private IPTV access network 226. In another particular embodiment, the EPG interface module 222 can be executable by the processor 204 to request data related to an EPG from a server within the IPTV system and to generate the EPG at the set-top box device 202.

The EPG interface module 222 can be executable by the processor 204 to transmit the EPG to the television monitor 212 via the display interface 210. In an illustrative embodiment, the EPG includes an indicator of a selectable option to view real-time ratings information, such as audience data and average reviews related to programs included in the EPG. The EPG interface module 222 can be executable by the processor 204 to receive a selection of the indicator from the remote control device 230, for example, and to provide the real-time ratings information via an updated EPG having the real-time ratings information. In one embodiment, the EPG interface module 222 can be executable by the processor 204 to request the updated EPG from a server within the IPTV system and to receive the updated EPG via the private IPTV access network 226. In another embodiment, the EPG interface module 222 can be executable by the processor 204 to request data related to the real-time ratings information from a server within the IPTV system and to generate the updated EPG having the real-time ratings information at the set-top box device.

In a particular embodiment, the EPG or updated EPG can include an indicator of a selectable option to submit a review related to a program. The EPG interface module 222 can be executable by the processor 204 to receive a selection of the indicator from a user and to prompt the user to submit a review. An example embodiment of a graphical user interface (GUI) to prompt a user to submit a review is illustrated in FIG. 9. The EPG interface module 222 can be executable by the processor 204 to receive the review and to transmit the review or data related to the review to a server within the IPTV system that stores reviews or determines average reviews.

In an illustrative embodiment, the EPG or updated EPG can include an indicator of a selectable option to view program rankings, for example, according to audience data. Additionally, the EPG or updated EPG can include an indicator of a selectable option to view program rankings that are segmented by program type. The EPG interface module 222 can be executable by the processor 204 to receive a selection to view segmented or non-segmented program rankings and to transmit a request for the program rankings to a server within the IPTV system. Further, the EPG interface module 222 can be executable by the processor 204 to receive the segmented or non-segmented program rankings from the server via the private IPTV access network 226 and to transmit the program rankings to the television monitor 212 via the display interface 210. In an alternative embodiment, the EPG interface module 222 can be executable by the processor 204 to generate the program rankings based on data related to the real-time ratings information that the set-top box 202 received via the IPTV access network 226.

The memory device 206 can also include a video content control and buffer module 224 that is executable by the processor 204 to receive multicast video content carried over a channel requested by a user and to buffer the video content before transmitting it to the display interface 210, in order to prevent underflow.

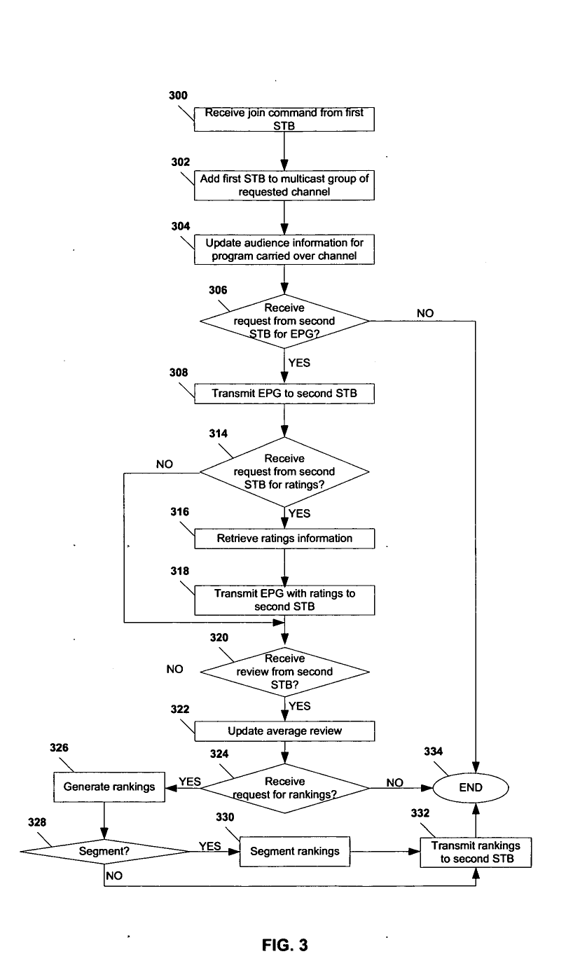

Referring to FIG. 3, a particular embodiment of a method of providing television ratings information is disclosed. At block 300, a server receives a join command from a first set-top box device to be added to a multicast group of a channel. In an illustrative embodiment, the request can be received from the first set-top box device at a program information server within an Internet Protocol Television (IPTV) system, such as the program information server 190 illustrated in FIG. 1. Moving to block 302, the server can add the first set-top box device to the multicast group of the requested channel. Continuing to block 304, the server can update audience data related to the program carried over the requested channel. In a particular embodiment, the audience data can be a total number of set-top boxes associated with the multicast group of the channel. In another embodiment, the audience data can be a percentage of total set-top boxes within a market area that are associated with the multicast group of the channel. The audience data can be maintained and updated at a multicast server that provides video content carried over the channel. Alternatively, the audience data can be maintained and updated at a server that collects audience data from a plurality of multicast servers.

Proceeding to decision step 306, in a particular embodiment, the server can determine whether it has received a request for an electronic program guide (EPG) from a second set-top box device. In one embodiment, the first set-top box device and second set-top box device can be the same set-top box device. If the server does not receive a request for an EPG, the method terminates at 334. Conversely, if the server receives a request for an EPG, the method moves to block 308, and the server transmits the EPG to the second set-top box device. In one embodiment, the server can be the program information server 190 illustrated in FIG. 1, and the server can push the EPG to the set-top box device, where it can be displayed at a television monitor coupled to the set-top box device.

In an illustrative embodiment, the EPG includes an indicator of a selectable option to view real-time ratings information, such as audience data and average reviews, related to programs included in the EPG. A user can select the indicator at the second set-top box device, for example, and the server can receive a request from the second set-top box device for real-time ratings information. Continuing to decision step 310, the server determines whether it has received a request from the second set-top box device for real-time ratings information. In a particular embodiment, if the server does not receive a request for real-time ratings information, the method proceeds to decision step 318 and continues as described. On the other hand, if the server receives a request for real-time ratings information, the method moves to block 316, and the server retrieves audience data and average reviews from its memory device or from one or more other servers, such as the multicast video content servers 180 illustrated in FIG. 1. Continuing to block 318, the server transmits an updated EPG having the real-time ratings information to the second set-top box device. The method then proceeds to decision step 320.

In a particular embodiment, the EPG can include an indicator of a selectable option to submit a program review. A user can select the indicator at the second set-top box device, for example, and the server can receive a request from the second set-top box device to submit the review. At decision step 320, the server determines whether it has received a review of a program from the second set-top box device, such as a numerical rating or a number of stars. If the server does not receive a review, the method can proceed to decision step 324. Whereas, if the server receives a review, the method proceeds to block 322, and the server can update an average review of the program related to the review that the second set-top box device submitted. The method then moves to decision step 324.

In an illustrative embodiment, the EPG can include an indicator of a selectable option to view program rankings according to audience data, for example. A user can select the indicator at the second set-top box device, for example, and the server can receive a request from the second set-top box device for program rankings. In one embodiment, the EPG can include indicators of selectable options for program rankings that are or are not segmented according to program type. Proceeding to decision step 324, the server determines whether it has received a request for program rankings from the second set-top box device. If the server has not received a request for program rankings from the second set-top box device, the method terminates at 334. Conversely, if the server has received a request for program rankings from the second set-top box device, the method continues to decision step 326, and the server generates the program rankings based on the audience data. The method then proceeds to decision step 328.

At decision step 328, the server determines whether segmented or non-segmented rankings have been requested. If non-segmented rankings have been requested, the method moves to block 332, and the server transmits the rankings to the second set-top box device. On the other hand, if segmented rankings have been requested, the method proceeds to block 330, and program rankings are segmented by program type. The program rankings are then transmitted to the second set-top box device at block 332. The method terminates at 334.

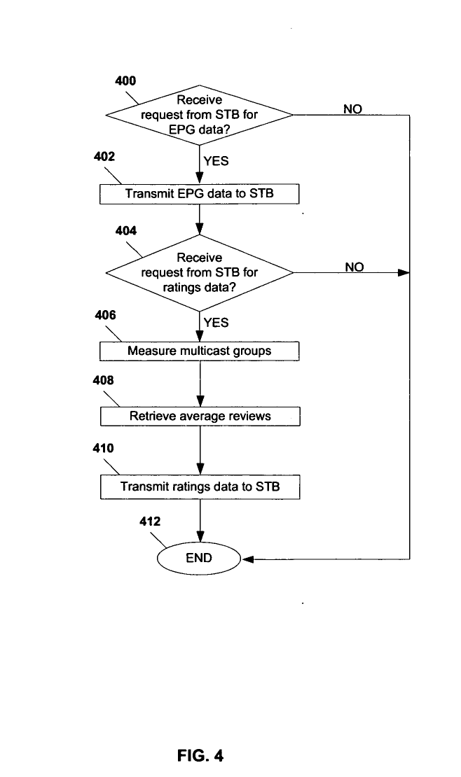

Referring to FIG. 4, a second illustrative embodiment of a method of providing television ratings information is illustrated. At block 400, a server receives a request from a set-top box device for data related to an electronic program guide (EPG). In an illustrative embodiment, the request can be received from the set-top box device at a program information server within an Internet Protocol Television (IPTV) system, such as the program information server 190 illustrated in FIG. 1. Moving to block 402, the server can transmit the EPG data to the set-top box device. In an illustrative embodiment, the set-top box device can generate an EPG from the data and transmit it to a display device, such as a television monitor coupled to the set-top box device.

In a particular embodiment, the EPG includes an indicator of a selectable option to view real-time ratings information, such as audience data and average reviews related to programs included in the EPG. A user can select the indicator at the set-top box device, for example, and the set-top box device can transmit a request for the real-time ratings information to the server. Proceeding to decision step 404, the server determines whether it has received a request from the set-top box device for the real-time ratings information. In a particular embodiment, if the server does not receive a request for real-time ratings information, the method terminates at 412. On the other hand, if the server receives a request for real-time ratings information, the server retrieves audience data and average reviews from its memory device or from one or more other servers, such as the multicast video content servers 180 illustrated in FIG. 1. In an illustrative embodiment, the method proceeds to block 406, and the server determines the audience data by measuring the number of set-top box devices in each of the multicast groups of available channels.

Additionally, at block 408, the server retrieves average reviews associated with programs carried over the available channels. The method then continues to block 410, and the server transmits data related to the real-time ratings information to the set-top box device. In a particular embodiment, the set-top box device can pull the data from the server and generate an updated EPG having the real-time ratings information. The method terminates at 412.

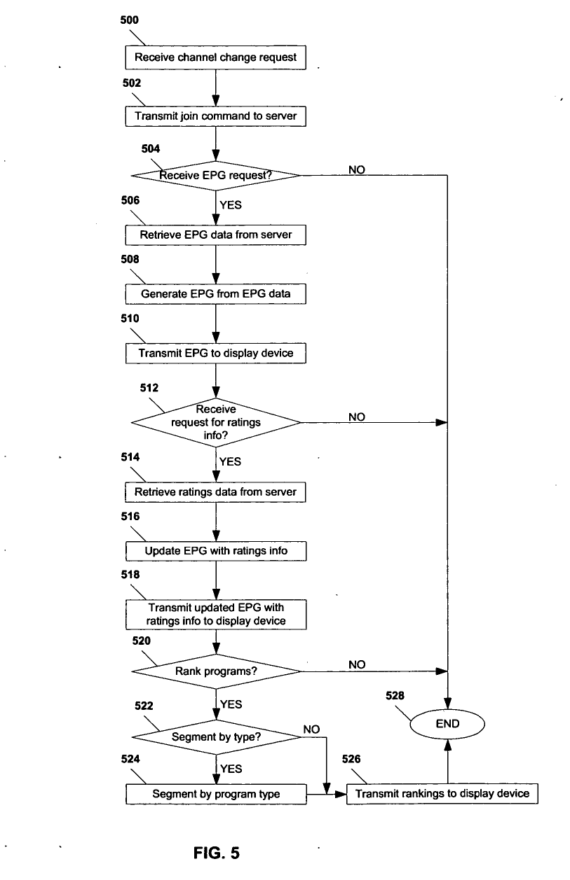

Referring to FIG. 5, an illustrative embodiment of a method of receiving television ratings information is illustrated. At block 500, a set-top box device receives a channel change request from a user. In a particular embodiment, the channel change request can be received via a remote control that communicates with the set-top box device. Moving to block 502, the set-top box device can transmit a join command to a multicast video content server within an Internet Protocol Television (IPTV) system to add the set-top box device to a multicast group associated with the requested channel.

Continuing to decision step 504, the set-top box device can determine whether it has received a request to view an electronic program guide (EPG) from the user. If the set-top box device does not receive a request to view the EPG, the method terminates at 528. Conversely, if the set-top box device receives a request to view the EPG, the method proceeds to block 506, and the set-top box device retrieves data related to the EPG from a server within the IPTV system. In an illustrative embodiment, the set-top box device can pull the data from a program information server, such as the program information server 190 illustrated in FIG. 1.

Moving to block 508, the set-top box device generates the EPG from the EPG data that it pulls from the server. Proceeding to block 510, the set-top box device transmits the EPG to a display device, such as a television monitor that is coupled to the set-top box device. In a particular embodiment, the EPG includes an indicator of a selectable option to view real-time ratings information, such as audience data and average reviews related to programs included in the EPG. A user can select the indicator at the set-top box device, and the set-top box device can pull data related to the real-time ratings information to the server.

Proceeding to decision step 512, the set-top box device determines whether it has received a request for real-time ratings information. In a particular embodiment, if the server does not receive a request for real-time ratings information, the method terminates at 528. On the other hand, if the set-top box device receives a request for real-time ratings information, such as audience data and average reviews, the method continues to block 514, and the set-top box device retrieves data related to the real-time ratings information from one or more servers within the IPTV system. In an illustrative embodiment, the set-top box device can pull the data from the program information server 190 or the multicast video content servers 180 illustrated in FIG. 1.

Continuing to block 516, the set-top box device generates an updated EPG having the real-time ratings information. Moving to block 518, the set-top box device transmits the updated EPG to the display device. In an illustrative embodiment, the EPG can include an indicator of a selectable option to view program rankings according to audience data or review data. The EPG can also include an indicator of a selectable option to view segmented program rankings according to program type. Proceeding to decision step 520, the set-top box device determines whether it has received a selection of the indicator from the user. If the set-top box device has not received a selection to view program rankings from the user, the method terminates at 528. On the other hand, if the set-top box device has not received a selection to view program rankings from the user, via a remote control device, for example, the method proceeds to decision step 522, and the set-top box determines whether it has received a request from the user to segment the rankings according to program types.

If the set-top box device has not received a request from the user to segment the rankings according to program type, the method moves to block 526, and the set-top box transmits program rankings that it has generated from the audience data that it pulled from the server, for example, to the display device. Whereas, if the set-top box device receives a request from the user to segment the rankings according to program type, the method moves to block 524, and the set-top box segments the program rankings that it has generated according to program type. The method then continues to block 526, and the set-top box device transmits the segmented rankings to the display device. The method terminates at 528.

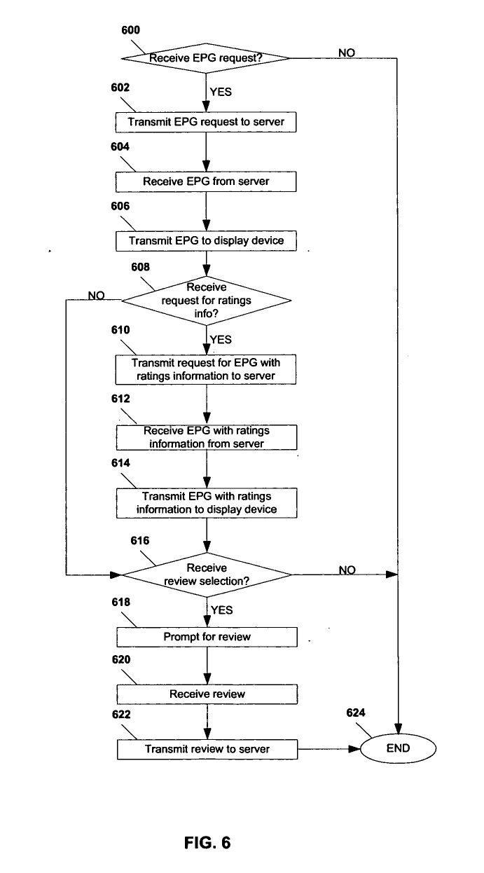

Referring to FIG. 6, a second illustrative embodiment of a method of receiving television ratings information is illustrated. At block 600, a set-top box device determines whether it has received a request to view an electronic program guide (EPG) from the user. In a particular embodiment, the request to view the EPG can be received via a remote control that communicates with the set-top box device. If the set-top box device does not receive a request to view the EPG, the method terminates at 624. Conversely, if the set-top box device receives a request to view the EPG, the method proceeds to block 602, and the set-top box device transmits a request for the EPG to a server within an Internet Protocol Television (IPTV) system. In an illustrative embodiment, the server can be the program information server 190 illustrated in FIG. 1.

Moving to block 604, the set-top box device receives the EPG from the server, for example, via a private access network of the IPTV system. In one embodiment, the server can push the EPG to the set-top box device, where it can be displayed at a display device, such as a television monitor coupled to the set-top box device. In a particular embodiment, the EPG includes an indicator of a selectable option to view real-time ratings information, such as audience data and average reviews related to programs included in the EPG. A user can select the indicator at the set-top box device, and the set-top box device can request the real-time ratings information from the server.

Proceeding to decision step 608, the set-top box device determines whether it has received a request for real-time ratings information. In a particular embodiment, if the server does not receive a request for real-time ratings information, the method moves to decision step 616 and continues as described. On the other hand, if the set-top box device receives a request for real-time ratings information, such as audience data and average reviews, the method continues to block 610, and the set-top box device transmits a request for an updated EPG having real-time ratings information from the server. The set-top box device receives an updated EPG having the ratings information at block 612. In an illustrative embodiment, the server can push the updated EPG having the ratings information to the set-top box device. Moving to block 614, the set-top box device transmits the updated EPG to the display device. The method then continues to decision step 616.

In a particular embodiment, the EPG can include an indicator of a selectable option to submit a review of a program. The user can issue a selection to submit a review, for example, by pressing a ratings information button on a remote control 128 or by using a remote control device to select a soft button on the EPG. At decision step 616, the set-top box device determines whether it has received a selection from the user to submit a review. In a particular embodiment, if the set-top box does not receive a selection from the user to submit a review, the method terminates at 624. Whereas, if the set-top box receives a selection from the user to submit a review, the method proceeds to block 618, and the set-top box device prompts the user to submit the review. An example of a graphical user interface to prompt the user to submit a review is illustrated in FIG. 9. A review can be a number of stars, for example, or any other suitable review that can be averaged with other reviews.

Continuing to block 620, the set-top box device receives the review from the user. The method then moves to block 622, and the set-top box device transmits the review to the server, where it can be stored or used to update an average review for the program with which the review is associated. The method terminates at 624.

Though the aspects of the disclosed methods have been presented in a certain order, for ease of description, certain portions of the method may be performed in a different order or simultaneously.

Referring to FIG. 7, an illustrative embodiment of a graphical user interface (GUI) 700 to provide television ratings information is illustrated. In a particular embodiment, the GUI 700 includes an electronic program guide (EPG) 702. The EPG 702 includes available channels 704 and programs 706 that are carried over each of the available channels 704. In an illustrative embodiment, the EPG can also include audience data 708 related to each program, such as a percentage of set-top box devices receiving each of the programs 706 within a market area, for example. The EPG can also include average reviews 710 of each of the programs 706, such as an average number of stars.

In one embodiment, the GUI 700 can also include a plurality of indicators of selectable options, such as soft buttons 712-720. The soft buttons can be selected, for example, by using arrow keys on a remote control device to manipulate a highlight bar 722 and by pressing an ‘OK,’ ‘ENTER,’ ‘SELECT,’ or similar key on the remote control device, when a desired soft button is highlighted. For example, the GUI can include a ‘RANK PROGRAMS’ indicator 712 of a selectable option to rank programs according audience data. The GUI can also include a ‘SUBMIT REVIEW’ indicator 714 of a selectable option to submit a review of a program. Additionally, the GUI can include a ‘RANKINGS OFF’ indicator 716 of a selectable option to turn off real-time ratings information on the EPG. Moreover, the GUI can include a ‘REFRESH RATINGS’ indicator 718 of a selectable option to refresh real-time ratings information on the EPG. Further, the GUI can include an ‘EXIT’ indicator 720 of a selectable option to exit the EPG and return to programming.

Referring to FIG. 8, an illustrative embodiment of a graphical user interface (GUI) 800 to provide television ratings information is illustrated. In a particular embodiment, the GUI 800 includes a program rankings screen 802 that is selectable from an electronic program guide (EPG). In an illustrative embodiment, the program rankings screen 802 can include program rankings that are segmented according to program type. For example, the program rankings section can include a ranked list of programs of a first program type 804, a ranked list of programs of a second program type 806, and ranked lists of programs of other program types. Each ranked list of programs includes the names 808 of the ranked programs. In a particular embodiment, each ranked list can also include audience data 810, for example, corresponding to each program 808.

In one embodiment, the GUI 800 can also include a plurality of indicators of selectable options, such as soft buttons 812-818. The soft buttons can be selected, for example, by using arrow keys on a remote control device to manipulate a highlight bar 820 and by pressing an ‘OK,’ ‘ENTER,’ ‘SELECT,’ or similar key on the remote control device, when a desired soft button is highlighted. For example, the GUI 800 can include a ‘NEXT’ indicator 812 of a selectable option to display a next page of ranked programs. The GUI 800 can also include a ‘PREV’ indicator 814 of a selectable option to display a previous page of ranked programs. Additionally, in an illustrative embodiment, the GUI 800 can include a ‘RANK ALL’ indicator 816 of a selectable option to display non-segmented rankings, i.e., rankings of programs that are not separated according to program type. Further, the GUI 800 can include an ‘EXIT’ indicator 818 of a selectable option to exit the program rankings screen 902 and return to the EPG or to programming.

Referring to FIG. 9, an illustrative embodiment of a graphical user interface (GUI) 900 to provide television ratings information is illustrated. In a particular embodiment, the GUI 900 includes a review submission screen 902 that can be selectable from an electronic program guide (EPG). In an illustrative embodiment, the review submission screen 902 can include program rankings that are segmented according to program type. For example, the review submission screen 902 can include a display of a program 904 that the user is watching. The review submission screen 902 can also include a review portion 906 that the user can use to select a review of the program. In the embodiment shown in FIG. 9, the review portion 906 can include a number of selectable stars.

In a particular embodiment, the GUI 900 can also include a plurality of indicators of selectable options, such as soft buttons 908-914. The soft buttons can be selected, for example, by using arrow keys on a remote control device to manipulate a highlight bar 916 and by pressing an ‘OK,’ ‘ENTER,’ ‘SELECT,’ or similar key on the remote control device, when a desired soft button is highlighted. For example, the GUI 900 can include a ‘HIGHER’ indicator 908 of a selectable option to increase the number of stars that are highlighted in the review section 906. The GUI 900 can also include a ‘LOWER’ indicator 910 of a selectable option to decrease the number of stars that are highlighted in the review section 906. Additionally, in an illustrative embodiment, the GUI 900 can include a ‘SUBMIT’ indicator 912 of a selectable option to display submit the review when the desired number of stars are highlighted in the review section 906. Further, the GUI 900 can include an ‘EXIT’ indicator 914 of a selectable option to exit the review submission screen 902 and return to the EPG or to programming.

In conjunction with the configuration of structure described herein, the system and method disclosed provide a user with an ability to request and view real-time ratings information related to programs in an electronic program guide (EPG) that is displayed at a display device coupled to a set-top box device. In a particular embodiment, the EPG can include an indicator of a selectable option to receive the real-time ratings information. An updated EPG that includes the real-time ratings information can be pushed to the set-top box device from a server within an Internet Protocol Television (IPTV) system, in response to a request for real-time ratings information from the set-top box device. Alternatively, data related to the updated EPG can be pulled from the server by the set-top box device, and the set-top box device can generate the updated EPG.

Real-time ratings information can include audience data, such as a number or percentage of set-top boxes in a market area, which are receiving a program or channel. The number or percentage of set-top boxes can be determined based on the sizes of multicast groups associated with each channel and can be updated in response to join commands or leave commands issued by set-top boxes in response to channel change requests. The real-time ratings information can also include average reviews of each program, such as an average number of stars submitted by set-top box users.

In another embodiment, the system and method allow users to interactively submit reviews of programs. For example, the EPG can include an indicator of a selectable option to submit a review of a program. A prompt for the review can be transmitted to a display device coupled to the set-top box device. In one embodiment, users can review programs based on a number of stars. The set-top box device can receive the review and transmit it to a server within the IPTV system. The server can store the review or update an average review of the program associated with the review.

The television or video content provider can summarize the audience data and reviews collected using various statistical methods and compile lists of the most popular television or video programming in real-time. In a particular embodiment, the EPG can include an indicator of a selectable option to view overall program rankings or program rankings that are segmented according to program type. For example, users can view program rankings related to sports, comedy, drama, action, news, documentary, educational, movie, or another program type. Programs can be ranked according to number of viewers or user ratings of each program. Nationwide ranking lists can be adjusted for time zones to improve accuracy for separate market areas. In one embodiment, program rankings can be pushed to a set-top box device in response to a request transmitted by the set-top box device to a server within the IPTV system. In another embodiment, the set-top box device can generate program rankings based on real-time ratings information pulled by the set-top box from a server within the IPTV system.

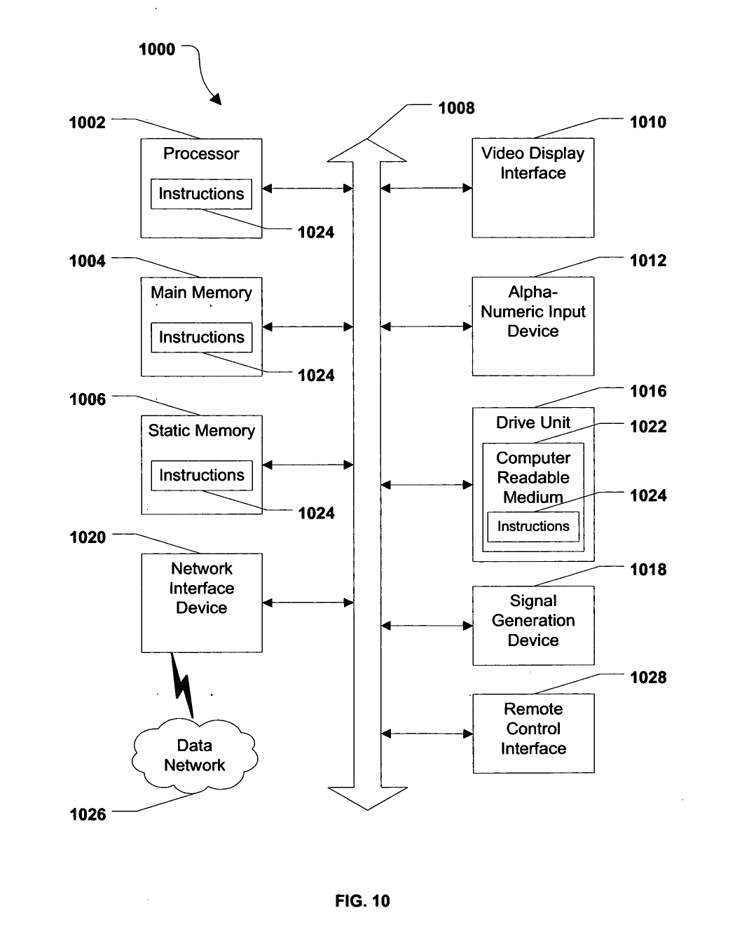

Referring to FIG. 10, an illustrative embodiment of a general computer system is shown and is designated 1000. The computer system 1000 can include a set of instructions that can be executed to cause the computer system 1000, or a portion thereof, to perform any one or more of the methods or computer based functions disclosed herein in connection with the set-top box device or with a network device. The computer system 1000, or any portion thereof, may operate as a standalone device or may be a hardware or software module within a server or set-top box device, as illustrated in FIGS. 1 and 2.

In a networked deployment, the computer system may operate in the capacity of server within an IPTV system or a set-top box device communicating therewith. The computer system 1000 can also be implemented as or incorporated into various other devices, or any other machine capable of executing a set of instructions (sequential or otherwise) that specify actions to be taken by that machine. In a particular embodiment, the computer system 1000 can be implemented using electronic devices that provide audio, video or data communication. Further, while a single computer system 1000 is illustrated, the term “system” shall also be taken to include any collection of systems or sub-systems that individually or jointly execute a set, or multiple sets, of instructions to perform one or more computer functions, such as the IPTV system illustrated in FIG. 1.

As illustrated in FIG. 10, the computer system 1000 may include a processor 1002, e.g., a central processing unit (CPU), a graphics-processing unit (GPU), or both. Moreover, the computer system 1000 can include a main memory 1004 and a static memory 1006 that can communicate with each other via a bus 1008. As shown, the computer system 1000 may further include a video display-unit 1010, such as a liquid crystal display (LCD), an organic light emitting diode (OLED), a flat panel display, a solid state display, or a cathode ray tube (CRT). Additionally, the computer system 1000 may include an input device 1012, such as a remote control input, an input control panel, a keyboard, a mouse, a gaming station input, or one or more keys disposed on a set-top box device. The computer system 1000 can also include a disk drive unit 1016, a signal generation device 1018, such as a speaker, and a network interface device 1020.

In an illustrative embodiment, the computer system 1000 can include a remote control interface 1028, such as the remote control interface 216 of the set-top box device illustrated in FIG. 2. The remote control interface 1028 can receive inputs from a remote control device.

In a particular embodiment, as depicted in FIG. 10, the disk drive unit 1016 may include a computer-readable medium 1022 in which one or more sets of instructions 1024, e.g. software, can be embedded. Further, the instructions 1024 may embody one or more of the methods or logic as described herein. In a particular embodiment, the instructions 1024 may reside completely, or at least partially, within the main memory 1004, the static memory 1006, and/or within the processor 1002 during execution by the computer system 1000. The main memory 1004 and the processor 1002 also may include computer-readable media.

In an alternative embodiment, dedicated hardware implementations, such as application specific integrated circuits, programmable logic arrays and other hardware devices, can be constructed to implement one or more of the methods described herein. Applications that may include the apparatus and systems of various embodiments can broadly include a variety of electronic and computer systems. One or more embodiments described herein may implement functions using two or more specific interconnected hardware modules or devices with related control and data signals that can be communicated between and through the modules, or as portions of an application-specific integrated circuit. Accordingly, the present system encompasses software, firmware, and hardware implementations.

In accordance with various embodiments of the present disclosure, the methods described herein may be implemented by software programs executable by a computer system. Further, in an exemplary, non-limited embodiment, implementations can include distributed processing, component/object distributed processing, and parallel processing. Alternatively, virtual computer system processing can be constructed to implement one or more of the methods or functionality as described herein.

The present disclosure contemplates a computer-readable medium that includes instructions 1024 or receives instructions 1024 responsive to a propagated signal, so that a device connected to a network 1026 can communicate audio, video or data over the network 1026. Further, the instructions 1024 may be transmitted or received over the network 1026 via the network interface device 1020.

While the computer-readable medium is shown to be a single medium, the term “computer-readable medium” includes a single medium or multiple media, such as a centralized or distributed database, and/or associated caches and servers that store one or more sets of instructions. The term “computer-readable medium” shall also include any medium that is capable of storing, encoding or carrying a set of instructions for execution by a processor or that cause a computer system to perform any one or more of the methods or operations disclosed herein.

In a particular non-limiting, exemplary embodiment, the computer-readable medium can include a solid-state memory such as a memory card or other package that houses one or more non-volatile read-only memories. Further, the computer-readable medium can be a random access memory or other volatile re-writable memory. Additionally, the computer-readable medium can include a magneto-optical or optical medium, such as a disk or tapes or other storage device to capture carrier wave signals such as a signal communicated over a transmission medium. A digital file attachment to an e-mail or other self-contained information archive or set of archives may be considered a distribution medium that is equivalent to a tangible storage medium. Accordingly, the disclosure is considered to include any one or more of a computer-readable medium or a distribution medium and other equivalents and successor media, in which data or instructions may be stored.

Although the present specification describes components and functions that may be implemented in particular embodiments with reference to particular standards and protocols, the invention is not limited to such standards and protocols. For example, standards for Internet and other packet switched network transmission (e.g., TCP/IP, UDP/IP, HTML, HTTP) represent examples of the state of the art. Such standards are periodically superseded by faster or more efficient equivalents having essentially the same functions. Accordingly, replacement standards and protocols having the same or similar functions as those disclosed herein are considered equivalents thereof.

The illustrations of the embodiments described herein are intended to provide a general understanding of the structure of the various embodiments. The illustrations are not intended to serve as a complete description of all of the elements and features of apparatus and systems that utilize the structures or methods described herein. Many other embodiments may be apparent to those of skill in the art upon reviewing the disclosure. Other embodiments may be utilized and derived from the disclosure, such that structural and logical substitutions and changes may be made without departing from the scope of the disclosure. Additionally, the illustrations are merely representational and may not be drawn to scale. Certain proportions within the illustrations may be exaggerated, while other proportions may be minimized. Accordingly, the disclosure and the figures are to be regarded as illustrative rather than restrictive.

One or more embodiments of the disclosure may be referred to herein, individually and/or collectively, by the term “invention” merely for convenience and without intending to voluntarily limit the scope of this application to any particular invention or inventive concept. Moreover, although specific embodiments have been illustrated and described herein, it should be appreciated that any subsequent arrangement designed to achieve the same or similar purpose may be substituted for the specific embodiments shown. This disclosure is intended to cover any and all subsequent adaptations or variations of various embodiments. Combinations of the above embodiments, and other embodiments not specifically described herein, will be apparent to those of skill in the art upon reviewing the description.

The Abstract of the Disclosure is provided to comply with 37 C.F.R. § 1.72(b) and is submitted with the understanding that it will not be used to interpret or limit the scope or meaning of the claims. In addition, in the foregoing Detailed Description, various features may be grouped together or described in a single embodiment for the purpose of streamlining the disclosure. This disclosure is not to be interpreted as reflecting an intention that the claimed embodiments require more features than are expressly recited in each claim. Rather, as the following claims reflect, inventive subject matter may be directed to less than all of the features of any of the disclosed embodiments. Thus, the following claims are incorporated into the Detailed Description, with each claim standing on its own as defining separately claimed subject matter.

The above-disclosed subject matter is to be considered illustrative, and not restrictive, and the appended claims are intended to cover all such modifications, enhancements, and other embodiments, which fall within the true spirit and scope of the present invention. Thus, to the maximum extent allowed by law, the scope of the present invention is to be determined by the broadest permissible interpretation of the following claims and their equivalents, and shall not be restricted or limited by the foregoing detailed description.

What is claimed is:

1. A method of providing television ratings information, the method comprising:
determining aggregated audience data associated with a program carried over a channel, wherein the aggregated audience data is collected from a number of set-top box devices associated with a multicast group of the channel;
receiving a request for real-time ratings information from a set-top box device; and
transmitting the real-time ratings information to the set-top box device, wherein the real-time ratings information includes the aggregated audience data.

2. The method of claim 1, further comprising:
receiving a join command from a new set-top box device to be added to the multicast group; and
determining revised audience data associated with the program, the revised audience data based on adding the new set-top box device to the multicast group.

3. The method of claim 1, further comprising:
receiving a leave command from a set-top box device to be removed from the multicast group; and
determining revised audience data associated with the program, the revised audience data based on removing the set-top box device to be removed from the multicast group.

4. The method of claim 1, further comprising:
receiving a request from the set-top box device for an electronic program guide (EPG);
generating the EPG, wherein the EPG includes an indicator of a selectable option to receive the real-time ratings information; and
transmitting the EPG to the set-top box device.

5. The method of claim 4, further comprising:
receiving a command from the set-top box device, the command related to a selection of the indicator;
updating the EPG to include the real-time ratings information; and
transmitting the updated EPG to the set-top box device.

6. The method of claim 1, further comprising receiving review data of the program from the set-top box device.

7. The method of claim 6, wherein the review data includes a number of stars.

8. The method of claim 6, further comprising determining an average review of the program at least partially based on the review data, wherein the real-time ratings information includes the average review.

9. The method of claim 8, further comprising:
comparing the aggregated audience data of the program to other aggregated audience data of each of a plurality of other programs; and
arranging the program and the plurality of other programs into a ranked list based on the aggregated audience data and the other aggregated audience data.

10. The method of claim 9, further comprising:
receiving a command from the set-top box device, the command related to a selection to receive the ranked list; and
transmitting the ranked list to the set-top box device.

11. The method of claim 10, wherein the ranked list includes at least one segment that includes programs of a program type.

12. The method of claim 11, wherein the program type is sports, comedy, drama, action, news, documentary, educational, or movie.

13. The method of claim 1, wherein the audience data includes a percentage of end user devices within a market area that are receiving the program.

14. The method of claim 13, wherein the market area is a national area, a regional area, a state area, a metropolitan area, a neighborhood area, or any combination thereof.

15. A method of receiving television ratings information, the method comprising:
issuing a request for real-time ratings information from a set-top box device to a server, wherein the real-time ratings information includes aggregated audience data of a program carried over a channel;
wherein the aggregated audience data is determined based on a number of other set-top box devices associated with a multicast group of the channel; and
receiving the real-time ratings information at the set-top box device.

16. The method of claim 15, further comprising:
receiving a request to view a channel at the set-top box device;
issuing a join command to the server, wherein the join command is a command to add the set-top box to a multicast group of the channel; and
wherein revised audience data is calculated based on data provided by the set-top box device being added to the multicast group.

17. The method of claim 15, further comprising:
receiving a selection at the set-top box device to view an electronic program guide (EPG);
issuing a request to the server for data related to the EPG;
receiving the data from the server; and
generating the EPG, wherein the EPG includes an indicator of a selectable option to receive the real-time ratings information.

18. The method of claim 17, further comprising transmitting the EPG to a display device.

19. The method of claim 17, further comprising:
receiving a user selection of the indicator at the set-top box device before issuing the request to receive the real-time ratings information;
receiving data related to the real-time ratings information from the server; and
generating an updated EPG that includes the real-time ratings information.

20. A system to provide television ratings information, the system comprising:
a server within an Internet Protocol Television (IPTV) system, the server having a processor and a memory device accessible to the processor;
wherein the memory device includes a ratings information module that is executable by the processor to determine aggregated audience data of a program carried over the channel, the aggregated audience data collected from a number of set-top box devices associated with the multicast group;
wherein the ratings information module is executable by the processor to transmit real-time ratings information to a set-top box device via an access network of the IPTV system, the real-time ratings information transmitted in response to a request to receive the ratings information; and
wherein the real-time ratings information includes the aggregated audience data.

21. The system of claim 20, wherein the server is a multicast video content server.

22. The system of claim 20, wherein the memory device includes an electronic program guide (EPG) module that is executable by the processor to generate an EPG that includes the real-time ratings information and to transmit the EPG to the set-top box device via the access network in response to a request from the set-top box device.

23. A system to receive television ratings information, comprising:
a set-top box having a processor and a memory device accessible to the processor;
wherein the memory device includes a command module that is executable by the processor to issue a join command to a server via an access network of an Internet Protocol Television (IPTV) system, the join command including a command to add the set-top box to a multicast group of a channel;
wherein the memory device includes a ratings information module that is executable by the processor to issue a request to the server via the access network to receive real-time ratings information of a program carried over the channel; and
wherein the real-time ratings information includes audience data of the program determined based on data from a number of set-top box devices associated with the multicast group.

24. The system of claim 23, wherein the command module is a channel change module that is executable by the processor to issue the join command in response to a channel change request from a user.

25. The system of claim 24, wherein the memory device includes an Internet Group Management Protocol (IGMP) module, wherein the processor issues a command to the IGMP module to issue the join command.

26. The system of claim 23, wherein the memory device includes an electronic program guide (EPG) module that is executable by the processor to:
transmit an EPG to a display device coupled to the set-top box device, wherein the EPG includes an indicator of a selectable option to receive the ratings information;
receive a selection of the indicator from the user before issuing the request to receive ratings information; and
transmit an updated EPG that includes the ratings information to the display device.

27. The system of claim 26, wherein the EPG module is executable by the processor to generate the EPG and the updated EPG based on data received from the server.

28. A computer program embedded in a computer-readable medium, the computer program comprising:
instructions to determine aggregated audience data of a program carried over a channel, wherein the aggregated audience data is collected from a number of set-top box devices associated with a multicast group of the channel;
instructions to receive a request for real-time ratings information from a set-top box device, wherein the real-time ratings information includes the aggregated audience data; and
instructions to transmit the real-time ratings information to the set-top box device.

29. The computer program of claim 28, wherein the multicast group includes at least one set-top box device receiving multicast video content of the channel.

30. A computer program embedded in a computer-readable medium, the computer program comprising:
instructions to issue a request for real-time ratings information from a set-top box device to a server via an access network of an Internet Protocol Television (IPTV) system, wherein the real-time ratings information includes aggregated audience data of a program carried over a channel;
wherein the aggregated audience data is determined based on data from a number of set-top box devices associated with a multicast group of the channel; and
instructions to communicate with the server via the access network to receive the real-time ratings information at the set-top box device.
